(19) United States
(12) Patent Application Publication
(10) Pub. No.: US 2022/0027413 A1
(43) Pub. Date: Jan. 27, 2022

(54) INLINE SEARCH QUERY REFINEMENT FOR NAVIGATION DESTINATION ENTRY

(71) Applicant: Rivian IP Holdings, LLC, Plymouth, MI (US)

(72) Inventors: Jason Quint, Ann Arbor, MI (US); Eric Ross Baker Wood, Menlo Park, CA (US); Kok Wei Koh, Mountain View, CA (US); Brennan Boblett, Orinda, CA (US)

(21) Appl. No.: 16/934,410

(22) Filed: Jul. 21, 2020

(51) Int. Cl. G06F 16/9032; G06F 16/909; G06F 16/9535; G06F 16/9537; G06F 21/31

(52) U.S. Cl. CPC G06F 16/90324; G06F 16/909; G06F 21/31; G06F 16/9537; G06F 16/9535

(57) ABSTRACT

A method and system operable for receiving a search query from a user; receiving contextual information; based on the contextual information, suggesting one or more of a search query refinement and a search query addition; receiving a selection of the one or more of the search query refinement and the search query addition from the user; based on the selection, forming a refined search query; and performing a search of a database based on the refined search query and returning corresponding results to the user.

### INTRODUCTION

The present disclosure relates generally to the automotive and navigation fields. More particularly, the present disclosure relates to inline search query refinement for navigation destination entry. This search query refinement is contextually aware. The statements made in this introduction merely provide background information related to the present disclosure and may not constitute prior art.

The process of refining search queries entered into a mobile device or the display of an in-vehicle navigation system is often cumbersome. By way of an example, if a user is driving to work without a route plotted in the navigation system of his or her vehicle, his or her normal coffee shop is closed, and he or she wants to find an alternative coffee shop on the way to work, one of the following processes must be followed: (1) enter a search query to find surrounding coffee shops and examine the search results to evaluate the location of options, traffic, etc. to determine how much time a detour would add to the commute; or (2) plot a route to work and search for coffee shops along the route, if the navigation system supports such searches. Both processes are time consuming and delay the ultimate goal of getting to work with coffee. By way of another example, if a user is driving on an interstate trip with a route plotted in the navigation system of his or her vehicle and he or she wants to get lunch about 40 minutes ahead, the following process must be followed: perform a mental calculation to determine how many miles will be traveled in 40 minutes, pan the map of the navigation system this many miles ahead along the plotted route, and search for a restaurant at approximately this location. Again, this process is time consuming, distracts the user from the task of driving, and delays the ultimate goal of getting to lunch and then the trip destination.

### BRIEF SUMMARY

The present disclosure provides inline search query refinement for navigation destination entry. This search query refinement is contextually aware, based on location, navigation route, day/time, vehicle state, prior search query, user identification, and the like and supplements conventional word prediction algorithms.

In one illustrative embodiment, the present disclosure provides a method, including: receiving a search query from a user; receiving contextual information; based on the contextual information, suggesting one or more of a search query refinement and a search query addition; receiving a selection of the one or more of the search query refinement and the search query addition from the user; based on the selection, forming a refined search query; and performing a search of a database based on the refined search query and returning corresponding results to the user. Receiving the contextual information includes one or more of: receiving location and/or road class and/or environmental information related to one or more of the user and a vehicle from a global positioning system; receiving navigation route information from one of a navigation system of the vehicle and a route planning application of a mobile device; receiving temporal information from one or more of a temporal device and a camera; receiving vehicle state and/or history information related to the vehicle from one or more of a sensor device of the vehicle and the camera; receiving prior search query and/or prior destination information from one of the navigation system of the vehicle and the mobile device; and receiving user identification information from one of a user identification system of the vehicle and a user identification application of the mobile device.

In another illustrative embodiment, the present disclosure provides a non-transitory computer-readable medium stored in a memory and executed by a processor to carry out the steps, including: receiving a search query from a user; receiving contextual information; based on the contextual information, suggesting one or more of a search query refinement and a search query addition; receiving a selection of the one or more of the search query refinement and the search query addition from the user; based on the selection, forming a refined search query; and performing a search of a database based on the refined search query and returning corresponding results to the user. Receiving the contextual information includes one or more of: receiving location and/or road class and/or environmental information related to one or more of the user and a vehicle from a global positioning system; receiving navigation route information from one of a navigation system of the vehicle and a route planning application of a mobile device; receiving temporal information from one or more of a temporal device and a camera; receiving vehicle state and/or history information related to the vehicle from one or more of a sensor device of the vehicle and the camera; receiving prior search query and/or prior destination information from one of the navigation system of the vehicle and the mobile device; and receiving user identification information from one of a user identification system of the vehicle and a user identification application of the mobile device.

In a further illustrative embodiment, the present disclosure provides a system, including: memory storing instructions executed by a processor for receiving a search query from a user; the memory storing instructions executed by the processor for receiving contextual information; the memory storing instructions executed by the processor, based on the contextual information, suggesting one or more of a search query refinement and a search query addition; the memory storing instructions executed by the processor receiving a selection of the one or more of the search query refinement and the search query addition from the user; the memory storing instructions executed by the processor, based on the selection, forming a refined search query; and the memory storing instructions executed by the processor performing a search of a database based on the refined search query and returning corresponding results to the user. Receiving the search query from the user includes receiving the search query from the user via a search query entry field of a display of a navigation system of a vehicle. Receiving the contextual information includes one or more of: receiving location and/or road class and/or environmental information related to one or more of the user and a vehicle from a global positioning system; receiving navigation route information from one of a navigation system of the vehicle and a route planning application of a mobile device; receiving temporal information from one or more of a temporal device and a camera; receiving vehicle state and/or history information related to the vehicle from one or more of a sensor device of the vehicle and the camera; receiving prior search query and/or prior destination information from one of the navigation system of the vehicle and the mobile device; and receiving user identification information from one of a user identification system of the vehicle and a user identification application of the mobile device. Suggesting the one or more of the search query refinement and the search query addition includes suggesting the one or more of the search query refinement and the search query addition via a search query suggestion field collocated with the search query entry field of the display of the navigation system of the vehicle. Receiving the selection of the one or more of the search query refinement and the search query addition from the user includes receiving the selection of the one or more of the search query refinement and the search query addition from the user via the display of the navigation system of the vehicle.

The foregoing brief summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Illustrative embodiments are illustrated in referenced figures of the drawings. It is intended that the embodiments and figures disclosed herein are to be considered illustrative rather than restrictive.

FIG. 1 is a schematic diagram illustrating an in-vehicle implementation of the search query refinement concept of the present disclosure.

FIG. 2 is a schematic diagram illustrating a mobile device implementation of the search query refinement concept of the present disclosure.

FIG. 3 is a schematic diagram illustrating vehicle navigation system and mobile device displays that a user uses to interact with the search query refinement algorithm of the present disclosure.

FIG. 4 is a flowchart illustrating the process flow of the search query refinement algorithm of the present disclosure.

FIG. 5 is a network diagram of a cloud-based system for implementing various cloud-based services of the present disclosure.

FIG. 6 is a block diagram of a server which may be used in the cloud-based system of FIG. 5, in other systems, or standalone.

FIG. 7 is a block diagram of a user device which may be used in the cloud-based system of FIG. 5, in other systems, or standalone.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Again, the present disclosure provides inline search query refinement for navigation destination entry. This search query refinement is contextually aware, based on location, navigation route, day/time, vehicle state, prior search query, user identification, and the like and supplements conventional word prediction algorithms. Refinement options are provided inline with a textual search query or following a verbal search query. The contextual extensions provide appended tags for a conventional search based on a query.

For example, on Monday morning at 8 am, if a user types “coffee shop” into the navigation system, a predictive bubble appears that says “on the way to work” appears, which can be selected and automatically appended to the “coffee shop” search, yielding “coffee shop on the way to work.” This refined search query can then be selected to find coffee shops along the user's route to work. Here, the day/time, vehicle location, and historical route data are used to provide the requisite context. The collocated suggestion menu may be a predictive bubble or an inline menu displayed adjacent to, above, below, to the left, or to the right of the search query entry field or search query text received from the user, after the search query is received from the user, in part or in whole. The collocated suggestion menu may include menu items that are displayed horizontally or vertically adjacent to each other. Each of the menu items may include text corresponding to the search query refinement or a search query addition. The menu items may be selected by one or more form among a touch of the menu item by the user or a speech input corresponding to the item.

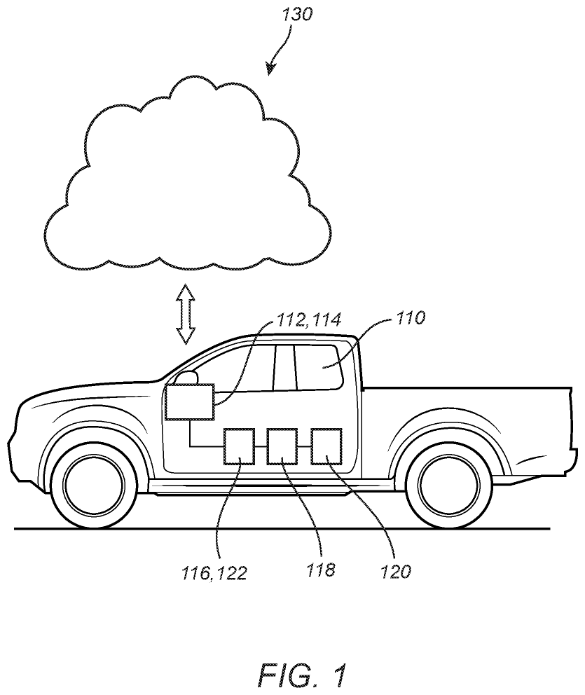

FIG. 1 is a schematic diagram illustrating an in-vehicle implementation of the search query refinement concept of the present disclosure. Here, a search query is entered into the navigation system 112 of the vehicle 110 via a touchscreen or joystick controlled keyboard interface provided on a display 114 of the navigation system 112. Alternatively, the search query is entered into the navigation system 112 of the vehicle 110 via a speech recognition algorithm or the like. When the search query is partially or wholly complete, with or without the use of conventional search query memory and/or word prediction algorithms, the processing system 116 of the navigation system 112 provides contextually aware suggested refinements and/or extensions to the search query, as is described in greater detail herein below. This contextual awareness may be based on location, road class, environmental business density, navigation route, day/time, vehicle state, vehicle history, prior search query, prior destination, user identification, and the like.

The locational contextual awareness may be provided via a global positioning system (GPS) 118 of the vehicle 110 or the like that is in communication with the navigation system 112, providing the navigation system 112 and the search query refinement algorithm with awareness of the position of the vehicle in the environment, direction of travel, speed, etc. For example, the locational contextual awareness may encompass road class, such as “highway,” which could lead to a predictive bubble, such as “easy off” and “easy on.” The locational contextual awareness may also encompass local business density and the like in formulating predictive bubbles.

The navigation route contextual awareness is provided via the navigation system 112 of the vehicle 110 itself, which knows what route has been plotted by a user and the current location of the vehicle along the plotted route, direction of travel, speed, etc. The navigation route contextual awareness also extends to prior destinations that have been visited, with or without route planning. This provides a great degree of intelligence, in that predictive bubbles can be provided related to searches based on destinations that a user may have visited before.

The day/time contextual awareness may be provided via the processing system 116 of the vehicle 110 or the like which is in communication with the navigation system 112, providing the navigation system 112 and the search query refinement algorithm with awareness of the temporal situation of the user, which may be correlated to likely travel routes, destinations, queried needs, etc. Further, day/time information may be gleaned from an image provided by a camera system of the vehicle 110, an ambient light sensor, or the like.

The vehicle state contextual awareness may be provided via a sensor system 120 and/or the processing system 116 of the vehicle 110 or the navigation system 112, providing the navigation system 112 and the search query refinement algorithm with awareness of the current status of the systems of the vehicle 110. Such status may include, for example, fuel level, oil level, other fluid level, battery state of charge, diagnosed problem, and the like. By way of example, if the user queries “coffee shop” when it is determined that the battery state of charge is low, then a suggested addition to the query could be “close to a charging station,” making the resulting selected query “coffee shop close to a charging station.” Further, recent environmental history of the vehicle 110 can be gleaned from camera images and the like, such that recent travel through inclement weather and/or dirty conditions can be detected, and an appropriate “near a car wash” predictive bubble can be provided, for example.

The prior search query contextual awareness may be provided via a memory 122 of the processing system 116 of the vehicle 110 or the navigation system 112 of the vehicle 110 itself, providing the navigation system 112 and the search query refinement algorithm with awareness of prior search queries and/or prior suggested refinements and/or additions to a given search query under similar circumstances. In this sense, the search query refinement algorithm is intelligent.

The user identification contextual awareness may be provided via the sensor system 120 of the vehicle 110 or the like that is in communication with the navigation system 112, providing the navigation system 112 and the search query refinement algorithm with awareness of the identification and state of a user, such as by detecting a key fob, detecting a mobile device, performing facial recognition of a camera image, assessing the state of the user (e.g., tired, sick, alone, with family, etc.) from the camera image, etc.

As illustrated, the processing and/or memory functionality of the navigation system 112 and the search query refinement algorithm may be partially or wholly resident remotely in the cloud 130, as opposed to locally. In this configuration, the vehicle 110 represents a node of the distributed network.

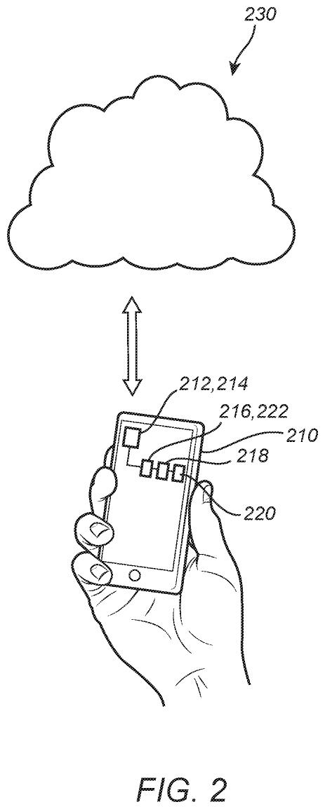

FIG. 2 is a schematic diagram illustrating a mobile device implementation of the search query refinement concept of the present disclosure. Here, a search query is entered into a navigation application 212 of the mobile device 210 via a touchscreen controlled keyboard interface provided on a display 214 of the navigation application 212. Alternatively, the search query is entered into the navigation application 212 of the mobile device 210 via a speech recognition algorithm or the like. When the search query is partially or wholly complete, with or without the use of conventional search query memory and/or word prediction algorithms, the processor 216 of the navigation application 212 provides contextually aware suggested refinements and/or extensions to the search query, as is described in greater detail herein below. This contextual awareness may be based on location, road class, environmental business density, navigation route, day/time, vehicle state, vehicle history, prior search query, prior destination, user identification, and the like.

The locational contextual awareness may be provided via a global positioning system (GPS) 218 of the mobile device 210 or the like that is in communication with the navigation application 212, providing the navigation application 212 and the search query refinement algorithm with awareness of the position of the user in the environment, direction of travel, speed, etc. For example, the locational contextual awareness may encompass road class, such as “highway,” which could lead to a predictive bubble, such as “easy off” and “easy on.” The locational contextual awareness may also encompass local business density and the like in formulating predictive bubbles.

The navigation route contextual awareness is provided via the navigation application 212 of the mobile device 210 itself, which knows what route has been plotted by a user and the current location of the user along the plotted route, direction of travel, speed, etc. The navigation route contextual awareness also extends to prior destinations that have been visited, with or without route planning. This provides a great degree of intelligence, in that predictive bubbles can be provided related to searches based on destinations that a user may have visited before.

The day/time contextual awareness may be provided via the processor 216 of the mobile device 210 or the like which is in communication with the navigation application 212, providing the navigation application 212 and the search query refinement algorithm with awareness of the temporal situation of the user, which may be correlated to likely travel routes, destinations, queried needs, etc. Further, day/time information may be gleaned from an image provided by a camera system of the mobile device 210, an ambient light sensor, or the like.

The user state contextual awareness may be provided via a sensor system 220 (such as a camera system) and/or the processor 216 of the mobile device 210 or the navigation application 212, providing the navigation application 212 and the search query refinement algorithm with awareness of the current status of the user. Such status may include, for example, alertness, health, etc.

The prior search query contextual awareness may be provided via a memory 222 of the processor 216 of the mobile device 210 or the navigation application 212 of the mobile device 210 itself, providing the navigation application 212 and the search query refinement algorithm with awareness of prior search queries and/or prior suggested refinements and/or additions to a given search query under similar circumstances. In this sense, the search query refinement algorithm is intelligent.

The user identification contextual awareness may be provided via the sensor system 220 of the mobile device 210 or the like that is in communication with the navigation application 212, providing the navigation application 212 and the search query refinement algorithm with awareness of the identification of a user, such as by performing facial recognition of a camera image, etc.

As illustrated, the processing and/or memory functionality of the navigation application 212 and the search query refinement algorithm may be partially or wholly resident remotely in the cloud 230, as opposed to locally. In this configuration, the mobile device 210 represents a node of the distributed network.

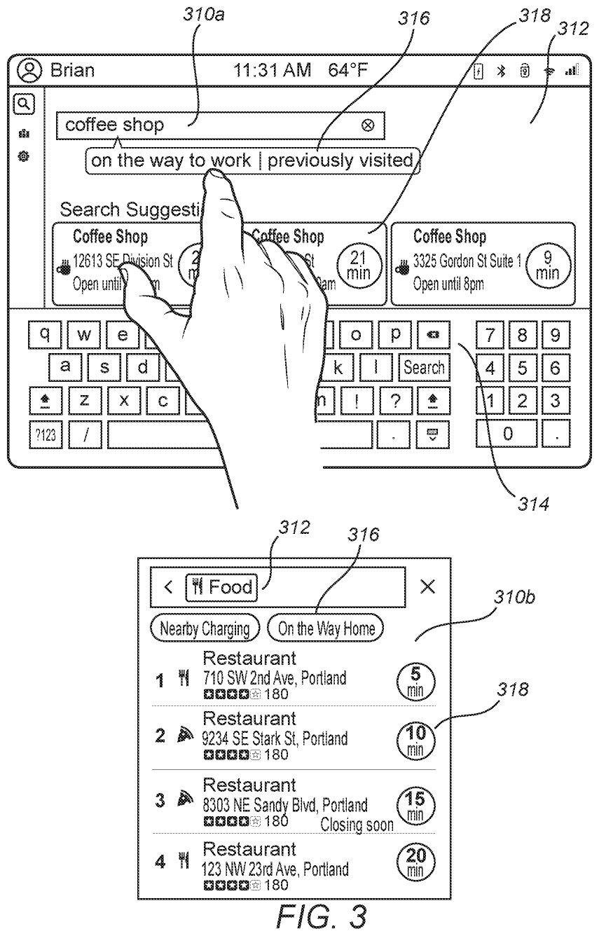

FIG. 3 is a schematic diagram illustrating vehicle navigation system and mobile device displays 310a and 310b, respectively, that a user uses to interact with the search query refinement algorithm of the present disclosure. The users enters a search query into a search query entry field 312 on the applicable display 310a or 310b, using a touch screen keyboard 314 or the like, with or without the use of conventional search query memory and/or word prediction algorithms. When the spacebar is tapped, or search query entry is otherwise ended, the search query refinement algorithm provides contextually aware suggested search query refinements and/or additions in a search query suggestion field 316. Again, these suggested search query refinements and/or additions utilize context based on location, navigation route, day/time, vehicle state, prior search query, user identification, and the like, and may leverage artificial intelligence (AI)/machine learning (ML) methodologies. The user can then select a suggested search query refinement from the search query suggestion field 316 and quickly and easily form a refined search query that may then return results, as is done conventionally. Destination information 318, including name, address, destination type, hours of operation, distance/time to destination, and the like may be provided in an ordered fashion. Of note here, the suggested search query refinements and/or additions are provided in a convenient-to-select manner on the applicable display 310a or 310b, such that the user can quickly and easily form a contextually aware search query with minimal effort and distraction. The same functionality can be achieved via a non-visual, voice controlled interface, with options selected from a corresponding auditory menu.

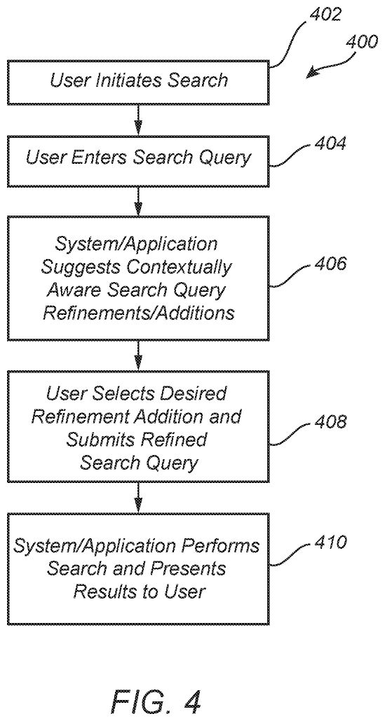

FIG. 4 is a flowchart illustrating the process flow 400 of the search query refinement algorithm of the present disclosure, which starts with the user initiating a search 402 utilizing his or her vehicle navigation system 112 (FIG. 1) or mobile device 210 (FIG. 2). The users enters a search query 404 into the search query entry field 312 (FIG. 3) on the applicable display 310a or 310b (FIG. 3), using the touch screen keyboard 314 (FIG. 3) or the like, with or without the use of conventional search query memory and/or word prediction algorithms. When the spacebar is tapped, or search query entry is otherwise ended, the search query refinement algorithm provides contextually aware suggested search query refinements and/or additions 406 in the search query suggestion field 316 (FIG. 3). Again, these suggested search query refinements and/or additions utilize context based on location, navigation route, day/time, vehicle state, prior search query, user identification, and the like, and may leverage AI/ML methodologies. The user can then select a suggested search query refinement 408 from the search query suggestion field 316 and quickly and easily form a refined search query that may then return results 410, as is done conventionally. Again, of note here, the suggested search query refinements and/or additions are provided in a convenient-to-select manner on the applicable display 310a or 310b, such that the user can quickly and easily form a contextually aware search query with minimal effort and distraction. The same functionality can be achieved via a non-visual, voice controlled interface, with options selected from a corresponding auditory menu. Thus, the present disclosure integrates contextually aware search query refinement directly into the search query entry functionality. This is beyond historical completion and word prediction functionality, as the universe of user, destination, and environment information is available for use to refine the search query in a meaningful way.

The following provides some germane examples of the functionality of the contextually aware search query refinement algorithm of the present disclosure:

| Condition | Entry | Suggestion | Refined Query |
|---|---|---|---|
| No route plotted | Coffee | On the way to work | Coffee on the way to work |
| Weekday morning <60 mi | | | |
| from work | | | |
| No route plotted | Food | On the way home | Food on the way home |
| Weekday evening >2 mi | | | |
| from home | | | |
| No route plotted | Seafood | Been here before | Seafood been here before |
| Similar prior search | | | |
| Route plotted | Tacos | Nearby or along the route | Tacos nearby or along the route |
| Route plotted | Charger | Easy off and back on | Charger easy off and back on |
| On divided highway | | | |
| Route plotted >1 hr trip | Restroom | Within 15 minutes | Restroom within 15 minutes |
| Low battery state of charge | Grocery store | Near a charger | Grocery store near a charger |

Again, by way of example, the locational contextual awareness may encompass road class, such as “highway,” which could lead to a predictive bubble, such as “easy off” and “easy on.” The locational contextual awareness may also encompass local business density and the like in formulating predictive bubbles. The navigation route contextual awareness also extends to prior destinations that have been visited, with or without route planning. This provides a great degree of intelligence, in that predictive bubbles can be provided related to searches based on destinations that a user may have visited before. Recent environmental history can be gleaned from camera images and the like, such that recent travel through inclement weather and/or dirty conditions can be detected, and an appropriate “near a car wash” predictive bubble can be provided, for example.

It is to be recognized that, depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

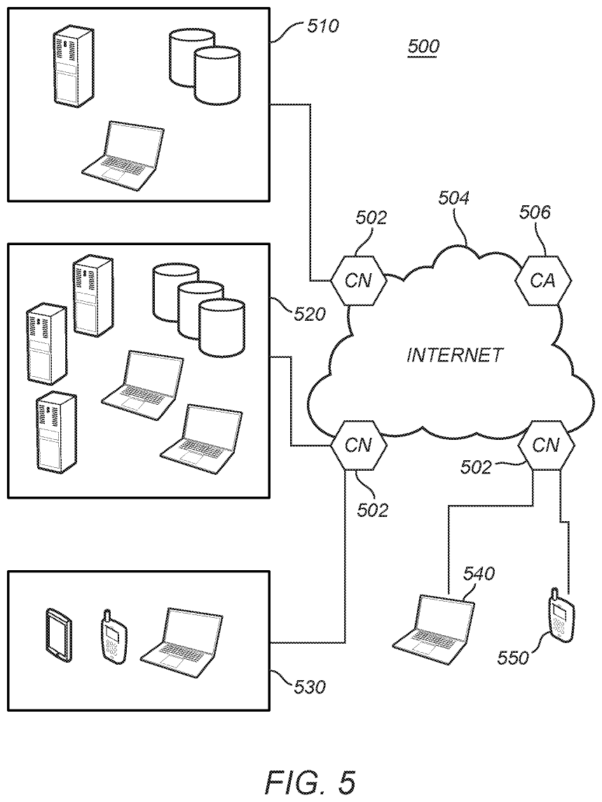

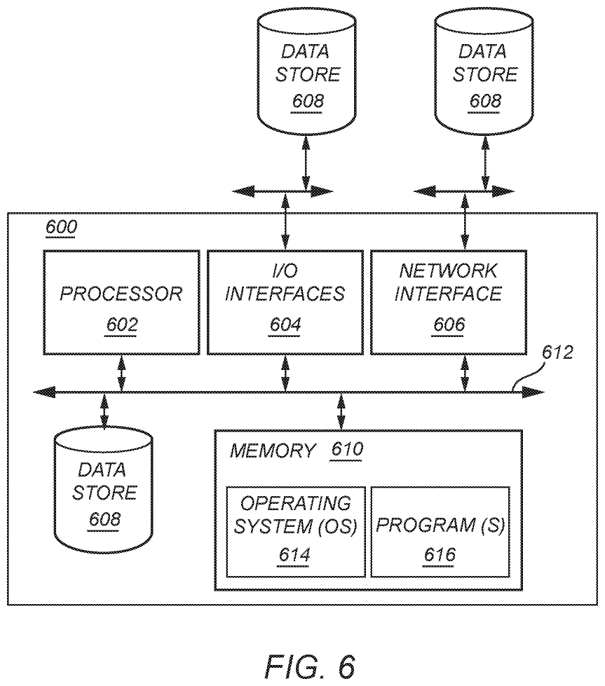

FIG. 5 is a network diagram of a cloud-based system 500 for implementing various cloud-based services of the present disclosure, which may also be implemented locally, such as within a vehicle. The cloud-based system 500 includes one or more cloud nodes (CNs) 502 communicatively coupled to the Internet 504 or the like. The cloud nodes 502 may be implemented as a server 600 (as illustrated in FIG. 6) or the like and can be geographically diverse from one another, such as located at various data centers around the country or globe. Further, the cloud-based system 500 can include one or more central authority (CA) nodes 506, which similarly can be implemented as the server 600 and be connected to the CNs 502. For illustration purposes, the cloud-based system 500 can connect to a regional office 510, headquarters 520, various employee's homes 530, laptops/desktops 540, and mobile devices 550, each of which can be communicatively coupled to one of the CNs 502. These locations 510, 520, and 530, and devices 540 and 550 are shown for illustrative purposes, and those skilled in the art will recognize there are various access scenarios to the cloud-based system 500, all of which are contemplated herein. The devices 540 and 550 can be so-called road warriors, i.e., users off-site, on-the-road, etc. The cloud-based system 500 can be a private cloud, a public cloud, a combination of a private cloud and a public cloud (hybrid cloud), or the like.

Again, the cloud-based system 500 can provide any functionality through services such as software-as-a-service (SaaS), platform-as-a-service, infrastructure-as-a-service, security-as-a-service, Virtual Network Functions (VNFs) in a Network Functions Virtualization (NFV) Infrastructure (NFVI), etc. to the locations 510, 520, and 530 and devices 540 and 550. Previously, the Information Technology (IT) deployment model included enterprise resources and applications stored within an enterprise network (i.e., physical devices), behind a firewall, accessible by employees on site or remote via Virtual Private Networks (VPNs), etc. The cloud-based system 500 is replacing the conventional deployment model. The cloud-based system 500 can be used to implement these services in the cloud without requiring the physical devices and management thereof by enterprise IT administrators.

Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application necessarily required. Centralization gives cloud service providers complete control over the versions of the browser-based and other applications provided to clients, which removes the need for version upgrades or license management on individual client computing devices. The phrase “software as a service” (SaaS) is sometimes used to describe application programs offered through cloud computing. A common shorthand for a provided cloud computing service (or even an aggregation of all existing cloud services) is “the cloud.” The cloud-based system 500 is illustrated herein as one example embodiment of a cloud-based system, and those of ordinary skill in the art will recognize the systems and methods described herein are not necessarily limited thereby.

FIG. 6 is a block diagram of a server 600, which may be used in the cloud-based system 500 (FIG. 5), in other systems, or standalone. For example, the CNs 502 (FIG. 5) and the central authority nodes 506 (FIG. 5) may be formed as one or more of the servers 600. The server 600 may be a digital computer that, in terms of hardware architecture, generally includes a processor 602, input/output (I/O) interfaces 604, a network interface 606, a data store 608, and memory 610. It should be appreciated by those of ordinary skill in the art that FIG. 6 depicts the server 600 in an oversimplified manner, and a practical embodiment may include additional components and suitably configured processing logic to support known or conventional operating features that are not described in detail herein. The components (602, 604, 606, 608, and 610) are communicatively coupled via a local interface 612. The local interface 612 may be, for example, but is not limited to, one or more buses or other wired or wireless connections, as is known in the art. The local interface 612 may have additional elements, which are omitted for simplicity, such as controllers, buffers (caches), drivers, repeaters, and receivers, among many others, to enable communications. Further, the local interface 612 may include address, control, and/or data connections to enable appropriate communications among the aforementioned components.

The processor 602 is a hardware device for executing software instructions. The processor 602 may be any custom made or commercially available processor, a central processing unit (CPU), an auxiliary processor among several processors associated with the server 600, a semiconductor-based microprocessor (in the form of a microchip or chipset), or generally any device for executing software instructions. When the server 600 is in operation, the processor 602 is configured to execute software stored within the memory 610, to communicate data to and from the memory 610, and to generally control operations of the server 600 pursuant to the software instructions. The I/O interfaces 604 may be used to receive user input from and/or for providing system output to one or more devices or components.

The network interface 606 may be used to enable the server 600 to communicate on a network, such as the Internet 504 (FIG. 5). The network interface 606 may include, for example, an Ethernet card or adapter (e.g., 10BaseT, Fast Ethernet, Gigabit Ethernet, or 10 GbE) or a Wireless Local Area Network (WLAN) card or adapter (e.g., 802.11a/b/g/n/ac). The network interface 606 may include address, control, and/or data connections to enable appropriate communications on the network. A data store 608 may be used to store data. The data store 608 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 608 may incorporate electronic, magnetic, optical, and/or other types of storage media. In one example, the data store 608 may be located internal to the server 600, such as, for example, an internal hard drive connected to the local interface 612 in the server 600. Additionally, in another embodiment, the data store 608 may be located external to the server 600 such as, for example, an external hard drive connected to the I/O interfaces 604 (e.g., a SCSI or USB connection). In a further embodiment, the data store 608 may be connected to the server 600 through a network, such as, for example, a network-attached file server.

The memory 610 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 610 may incorporate electronic, magnetic, optical, and/or other types of storage media. Note that the memory 610 may have a distributed architecture, where various components are situated remotely from one another but can be accessed by the processor 602. The software in memory 610 may include one or more software programs, each of which includes an ordered listing of executable instructions for implementing logical functions. The software in the memory 610 includes a suitable operating system (O/S) 614 and one or more programs 616. The operating system 614 essentially controls the execution of other computer programs, such as the one or more programs 616, and provides scheduling, input-output control, file and data management, memory management, and communication control and related services. The one or more programs 616 may be configured to implement the various processes, algorithms, methods, techniques, etc. described herein.

It will be appreciated that some embodiments described herein may include one or more generic or specialized processors (“one or more processors”) such as microprocessors; central processing units (CPUs); digital signal processors (DSPs); customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

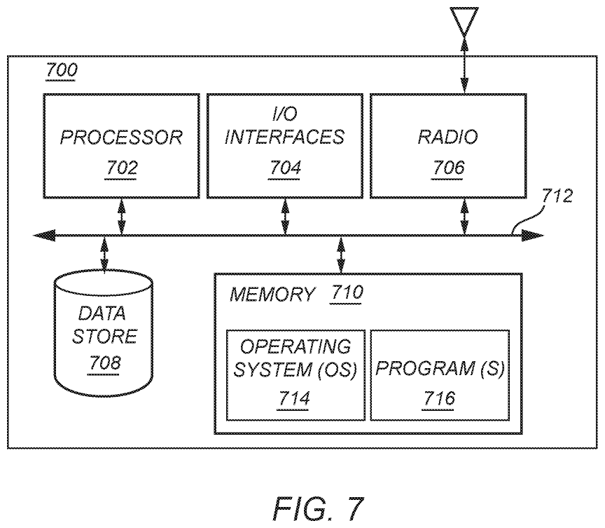

FIG. 7 is a block diagram of a user device 700, which may be used in the cloud-based system 500 (FIG. 5), in other systems, or standalone. Again, the user device 700 can be a smartphone, a tablet, a smartwatch, an Internet of Things (IoT) device, a laptop, a virtual reality (VR) headset, a vehicle processing/control device or system, etc. The user device 700 can be a digital device that, in terms of hardware architecture, generally includes a processor 702, I/O interfaces 704, a radio 706, a data store 708, and memory 710. It should be appreciated by those of ordinary skill in the art that FIG. 7 depicts the user device 700 in an oversimplified manner, and a practical embodiment may include additional components and suitably configured processing logic to support known or conventional operating features that are not described in detail herein. The components (702, 704, 706, 708, and 710) are communicatively coupled via a local interface 712. The local interface 712 can be, for example, but is not limited to, one or more buses or other wired or wireless connections, as is known in the art. The local interface 712 can have additional elements, which are omitted for simplicity, such as controllers, buffers (caches), drivers, repeaters, and receivers, among many others, to enable communications. Further, the local interface 712 may include address, control, and/or data connections to enable appropriate communications among the aforementioned components.

The processor 702 is a hardware device for executing software instructions. The processor 702 can be any custom made or commercially available processor, a CPU, an auxiliary processor among several processors associated with the user device 700, a semiconductor-based microprocessor (in the form of a microchip or chipset), or generally any device for executing software instructions. When the user device 700 is in operation, the processor 702 is configured to execute software stored within the memory 710, to communicate data to and from the memory 710, and to generally control operations of the user device 700 pursuant to the software instructions. In an embodiment, the processor 702 may include a mobile optimized processor such as optimized for power consumption and mobile applications. The I/O interfaces 704 can be used to receive user input from and/or for providing system output. User input can be provided via, for example, a keypad, a touch screen, a scroll ball, a scroll bar, buttons, a barcode scanner, and the like. System output can be provided via a display device such as a liquid crystal display (LCD), touch screen, and the like.

The radio 706 enables wireless communication to an external access device or network. Any number of suitable wireless data communication protocols, techniques, or methodologies can be supported by the radio 706, including any protocols for wireless communication. The data store 708 may be used to store data. The data store 708 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 708 may incorporate electronic, magnetic, optical, and/or other types of storage media.

Again, the memory 710 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 710 may incorporate electronic, magnetic, optical, and/or other types of storage media. Note that the memory 710 may have a distributed architecture, where various components are situated remotely from one another, but can be accessed by the processor 702. The software in memory 710 can include one or more software programs, each of which includes an ordered listing of executable instructions for implementing logical functions. In the example of FIG. 7, the software in the memory 710 includes a suitable operating system 714 and programs 716. The operating system 714 essentially controls the execution of other computer programs and provides scheduling, input-output control, file and data management, memory management, and communication control and related services. The programs 716 may include various applications, add-ons, etc. configured to provide end user functionality with the user device 700. For example, example programs 716 may include, but not limited to, a web browser, social networking applications, streaming media applications, games, mapping and location applications, electronic mail applications, financial applications, and the like. In a typical example, the end-user typically uses one or more of the programs 716 along with a network such as the cloud-based system 500 (FIG. 5).

Thus, the present disclosure provides inline search query refinement for navigation destination entry. This search query refinement is contextually aware, based on location, navigation route, day/time, vehicle state, prior search query, user identification, and the like and supplements conventional word prediction algorithms.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (for example “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (for example, “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (for example, the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

Although the present disclosure is illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following non-limiting claims for all purposes.

What is claimed is:

1. A method, comprising:
receiving a search query from a user;
receiving contextual information;
based on the contextual information, suggesting one or more of a search query refinement and a search query addition;
receiving a selection of the one or more of the search query refinement and the search query addition from the user;
based on the selection, forming a refined search query; and
performing a search of a database based on the refined search query and returning corresponding results to the user.

2. The method of claim 1, wherein receiving the search query from the user comprises receiving the search query from the user via a search query entry field of a display of a navigation system of a vehicle.

3. The method of claim 1, wherein receiving the search query from the user comprises receiving the search query from the user via a search query entry field a display of a mobile device.

4. The method of claim 1, wherein receiving the contextual information comprises one or more of:
receiving one or more of location, road class, and environmental information related to one or more of the user and a vehicle from a global positioning system;
receiving navigation route information from one of a navigation system of the vehicle and a route planning application of a mobile device;
receiving temporal information from one or more of a temporal device and a camera;
receiving one or more of vehicle state and history information related to the vehicle from one or more of a sensor device of the vehicle and the camera;
receiving one or more of prior search query and prior destination information from one of the navigation system of the vehicle and the mobile device; and
receiving user identification information from one of a user identification system of the vehicle and a user identification application of the mobile device.

5. The method of claim 2, wherein suggesting the one or more of the search query refinement and the search query addition comprises suggesting the one or more of the search query refinement and the search query addition via a search query suggestion field collocated with the search query entry field of the display of the navigation system of the vehicle.

6. The method of claim 3, wherein suggesting the one or more of the search query refinement and the search query addition comprises suggesting the one or more of the search query refinement and the search query addition via a search query suggestion field collocated with the search query entry field of the display of the mobile device.

7. The method of claim 5, wherein receiving the selection of the one or more of the search query refinement and the search query addition from the user comprises receiving the selection of the one or more of the search query refinement and the search query addition from the user via the display of the navigation system of the vehicle.

8. The method of claim 6, wherein receiving the selection of the one or more of the search query refinement and the search query addition from the user comprises receiving the selection of the one or more of the search query refinement and the search query addition from the user via the display of the mobile device.

9. A non-transitory computer-readable medium stored in a memory and executed by a processor to carry out the steps, comprising:
receiving a search query from a user;
receiving contextual information;
based on the contextual information, suggesting one or more of a search query refinement and a search query addition;
receiving a selection of the one or more of the search query refinement and the search query addition from the user;
based on the selection, forming a refined search query; and
performing a search of a database based on the refined search query and returning corresponding results to the user.

10. The non-transitory computer-readable medium of claim 9, wherein receiving the search query from the user comprises receiving the search query from the user via a search query entry field of a display of a navigation system of a vehicle.

11. The non-transitory computer-readable medium of claim 9, wherein receiving the search query from the user comprises receiving the search query from the user via a search query entry field a display of a mobile device.

12. The non-transitory computer-readable medium of claim 9, wherein receiving the contextual information comprises one or more of:
receiving one or more of location, road class, and environmental information related to one or more of the user and a vehicle from a global positioning system;
receiving navigation route information from one of a navigation system of the vehicle and a route planning application of a mobile device;
receiving temporal information from one or more of a temporal device and a camera;
receiving one or more of vehicle state and history information related to the vehicle from one or more of a sensor device of the vehicle and the camera;
receiving one or more of prior search query and prior destination information from one of the navigation system of the vehicle and the mobile device; and
receiving user identification information from one of a user identification system of the vehicle and a user identification application of the mobile device.

13. The non-transitory computer-readable medium of claim 10, wherein suggesting the one or more of the search query refinement and the search query addition comprises suggesting the one or more of the search query refinement and the search query addition via a search query suggestion field collocated with the search query entry field of the display of the navigation system of the vehicle.

14. The non-transitory computer-readable medium of claim 11, wherein suggesting the one or more of the search query refinement and the search query addition comprises suggesting the one or more of the search query refinement and the search query addition via a search query suggestion field collocated with the search query entry field of the display of the mobile device.

15. The non-transitory computer-readable medium of claim 13, wherein receiving the selection of the one or more of the search query refinement and the search query addition from the user comprises receiving the selection of the one or more of the search query refinement and the search query addition from the user via the display of the navigation system of the vehicle.

16. The non-transitory computer-readable medium of claim 14, wherein receiving the selection of the one or more of the search query refinement and the search query addition from the user comprises receiving the selection of the one or more of the search query refinement and the search query addition from the user via the display of the mobile device.

17. A system, comprising:
memory storing instructions executed by a processor for receiving a search query from a user;
the memory storing instructions executed by the processor for receiving contextual information;
the memory storing instructions executed by the processor, based on the contextual information, suggesting one or more of a search query refinement and a search query addition;
the memory storing instructions executed by the processor receiving a selection of the one or more of the search query refinement and the search query addition from the user;
the memory storing instructions executed by the processor, based on the selection, forming a refined search query; and
the memory storing instructions executed by the processor performing a search of a database based on the refined search query and returning corresponding results to the user.

18. The system of claim 17, wherein receiving the search query from the user comprises receiving the search query from the user via a search query entry field of a display of a navigation system of a vehicle.

19. The system of claim 17, wherein receiving the contextual information comprises one or more of:
receiving one or more of location, road class, and environmental information related to one or more of the user and a vehicle from a global positioning system;
receiving navigation route information from one of a navigation system of the vehicle and a route planning application of a mobile device;
receiving temporal information from one or more of a temporal device and a camera;
receiving one or more of vehicle state and history information related to the vehicle from one or more of a sensor device of the vehicle and the camera;
receiving one or more of prior search query and prior destination information from one of the navigation system of the vehicle and the mobile device; and
receiving user identification information from one of a user identification system of the vehicle and a user identification application of the mobile device.

20. The system of claim 18, wherein suggesting the one or more of the search query refinement and the search query addition comprises suggesting the one or more of the search query refinement and the search query addition via a search query suggestion field collocated with the search query entry field of the display of the navigation system of the vehicle, and wherein receiving the selection of the one or more of the search query refinement and the search query addition from the user comprises receiving the selection of the one or more of the search query refinement and the search query addition from the user via the display of the navigation system of the vehicle.
